(19) United States
(12) Patent Application Publication
(10) Pub. No.: US 2010/0025130 A1
(43) Pub. Date: Feb. 4, 2010

(54) FUEL ENGINE SERVO LOADING DEVICE AND OPTIMAL EFFICIENCY OPERATING CONTROL METHOD THEREOF

(75) Inventor: Hong Lv, Guilin City (CN)

Correspondence Address: CALFEE HALTER & GRISWOLD, LLP, 800 SUPERIOR AVENUE, SUITE 1400, CLEVELAND, OH, 44114, US

(73) Assignee: Guilin Geely Stars Oil-Electric Hybrid Engine Co., Guilin City (CN)

(21) Appl. No.: 12/529,035

(22) PCT Filed: Sep. 21, 2007
(86) PCT No.: PCT/CN07/02792

§ 371 Date: Aug. 28, 2009

(30) Foreign Application Priority Data
Mar. 1, 2007 (CN) 200710048570.8
Mar. 6, 2007 (CN) 200720078746.X

(51) Int. Cl. B60K 6/485; G06F 19/00; B60W 10/04; B60W 20/00

(52) U.S. Cl. 180/65.26; 701/22; 180/65.21

(57) ABSTRACT

A fuel engine servo loading device is disclosed, which comprises a permanent magnet machine having a first rotor and a second rotor, the first rotor of the machine is directly connected with the output shaft of the fuel engine, the second rotor of the machine is directly connected with a driving shaft, power is transmitted between the first rotor and the second rotor via electromagnetic coupling, characterized in that, the fuel engine servo loading device further comprises a servo driver, which controls the electromagnetic torque between the first rotor and the second rotor according to set conditions so as to control the torque load of the fuel engine and the output torque of the driving shaft; wherein, a speed/position sensor is provided on the first rotor shaft, and a position sensor is provided on the second rotor shaft for performing torque servo control; and a conductive slip ring is provided on the rotor shaft at which an armature winding is mounted, wherein the conductive slip ring connects the winding with the servo driver. Thereby the engine always operates in accordance with the optimal efficiency operating curve so as to output maximum mechanical energy at the same fuel consumption.

### FIELD OF THE INVENTION

The present invention relates to a fuel engine servo loading device and optimal efficiency operating control method thereof. More particularly, this invention relates to a fuel engine servo loading device and optimal efficiency operating control method thereof which make the engine always operate on the optimal efficiency operating curve at different rotational speed, so that the engine obtains maximum mechanical energy when consuming equal fuel so as to achieve the purpose of saving energy resources.

### BACKGROUND OF THE INVENTION

Tests have shown that, a fuel engine outputting a certain mechanical power may have a number of operating points at which different rotational speed matches with different torque, and there is a minimum fuel consumption point, i.e., the optimal rotational speed-torque mating operating point in the plurality of operating points at which the engine output the same mechanical power. The curve obtained by connecting the minimum fuel consumption points of different output power and smoothing the same is the optimal efficiency operating curve of this engine. On this curve, the efficiency of the fuel engine is the highest, that is, consuming equal fuel results in the maximum mechanical energy. FIG. 1 is the optimal efficiency operating curve of a 1.8 L gasoline engine, in the figure, the longitudinal coordinate is the torque of the engine output shaft (in unit of N·m), the horizontal coordinate is the rotational speed of the engine output shaft (in unit of rpm), wherein the thin dash line is equipower line (in unit of kW), the thin solid line is equi-energy consumption line (in unit of g/kWh), the thick solid line is the optimal efficiency operating curve of the engine, and the thick dash line is the maximum torque limit of the engine.

It can be seen that, when the fuel engine operates at certain rotational speed, if the torque applied to the shaft thereof is equal to the torque required by the optimal efficiency operating curve at current rotational speed, the engine then operates at the optimal efficiency point at the current rotational speed. At different rotational speed, the engine keeps the torque applied to the shaft always be equal to the torque required by the optimal efficiency operating curve, i.e., the rotational speed-torque of the engine conforms to the requirements of the optimal efficiency operating curve, thus the engine consuming equal fuel will obtain the maximum mechanical energy so as to achieve the most economical operating state.

A variety of fuel engines in current vehicles are all equipped with mechanical transmission mechanisms such as stepped transmissions and continuously variable transmissions (CVT), to adjust matching rotational speed and torque so as to expect the rotational speed-torque of the engine to approach the optimal efficiency operating curve.

The most commonly applied stepped transmissions have 4-5 speed gear and can perform simple speed adjustment, but the transmission ratio cannot be continuously adjusted. When the load torque changes due to wind resistance, load, road condition, environment, wear, etc, the torque applied to the engine shaft at different rotational speeds of different gears can hardly conform to the requirements of the optimal efficiency operating curve.

One type of continuously variable transmission mainly comprises a driving wheel set, a driven wheel set, a metal belt and a hydraulic pump, and achieves the continuous variation of the transmission ratio by changing the work radius of the driving wheel, the cone of the driven wheel engaging with the V-shaped drive belt, so as to achieve better matching of the rotational speed-torque of the engine. However, the continuously variable transmission also has evident limitations: firstly, the mechanical structure is relatively complex, and thus the manufacture cost thereof is relatively high; secondly, the mechanical structure and the hydraulic system have large inertia, and thus the adjustment speed is slow, when the engine throttle or external load torque changes dynamically, especially when the road condition changes frequently, the throttle changes frequently and shift frequently, the continuously variable transmission (CVT) cannot rapidly and precisely adjust the transmission ratio, so the probability that the fuel engine operates at the optimal efficiency operating curve is still low; additionally, the transmission efficiency of the continuously variable transmission (CVT) is lower than that of a general gear transmission. These disadvantages all influence the popularization and application of CVT.

Once the fuel engine is equipped with torque servo loading device, it obtains mating torque data based on current rotational speed according to the actual rotational speed of the engine and the optimal efficiency operating curve pre-stored in the computer of the main control unit, and the fuel engine is rendered to operate in accordance with the pre-stored optimal efficiency operating curve by the electric machine of the servo device applying corresponding torque to the fuel engine, thereby greatly improving the operating efficiency of the fuel engine, thus evidently realizing energy saving.

### SUMMARY OF THE INVENTION

The object of the present invention is to design a fuel engine servo loading device and optimal efficiency operating control method thereof. The present device and control method is free from the influence of external load state, such as vehicle speed and drag force, and independently adjusts the torque of the engine output shaft, so that the load torque born by the engine shaft always makes almost non-hysteretic match with the rotational speed according to the optimal efficiency operating curve when the fuel engine operates at different rotational speeds, thereby the engine continuously and steadily operates in an energy saving way.

According to one aspect of the present invention, a fuel engine servo loading device is provided, which comprises a permanent magnet machine having a first rotor and a second rotor, the first rotor of the machine is directly connected with the output shaft of the fuel engine, the second rotor of the machine is directly connected with a driving shaft, power is transmitted between the first rotor and the second rotor via electromagnetic coupling, characterized in that, the fuel engine servo loading device further comprises a servo driver, which controls the electromagnetic torque between the first rotor and the second rotor according to set conditions so as to control the torque load of the fuel engine and the output torque of the driving shaft; wherein a speed/position sensor is provided on the first rotor shaft, and a position sensor is provided on the second rotor shaft for performing torque servo control; and a conductive slip ring is provided on the rotor shaft at which an armature winding is mounted, wherein the conductive slip ring connects the winding with the servo driver.

According to another aspect of the present invention, an optimal efficiency operating control method of a fuel engine servo loading device is provided, wherein the fuel engine is provided with said fuel engine servo loading device as described above which matches with the maximum torque and the maximum rotational speed thereof, characterized in that, said method comprises the following steps:

1) real-time monitoring the rotational speed of the first rotor of the machine by a speed/position sensor when the engine is operating;

2) the main control unit deriving the optimal torque matching with the speed based on speed signal according to the rotational speed-torque matching data or the rotational speed-torque matching relation formula of the optimal efficiency operating curve pre-stored in the computer, and transmitting the derived torque setting value to the torque servo driver;

3) the servo driver deriving the direction of the current vector outputting to the winding of the first rotor or the second rotor based on the relative position signal between the first rotor and the second rotor derived from the absolute position signal of the first rotor and the second rotor according to the principle that current has the same phase with counter-electromotive force;

4) the servo driver deriving the magnitude of the current vector outputting to the winding of the first rotor or the second rotor based on the torque setting value transmitted by the main control unit;

5) the servo driver determining the magnitude of the instantaneous current value of respective phase windings based on the derived direction and magnitude of the current vector, and enabling the machine to realize torque servo control by respective phase current close-loop control, thereby rendering the engine to operate in accordance with the optimal efficiency operating curve based on the optimal toque value load matching current engine rotational speed and at the same time the second rotor shaft outputting the torque to the load; and

6) the main control unit and the servo driver repeating the steps of 1) to 5), thus circularly and dynamically obtaining current engine rotational speed, and deriving new torque setting value based on new current rotational speed and the pre-stored optimal efficiency curve data, and the torque servo driver applying corresponding new torque value to the engine shaft and operating by following the torque required by the engine optimal efficiency operating curve according to the rotational speed.

According to still another aspect of the present invention, a power output device is provided, which comprises a fuel engine and a permanent magnet machine having a first rotor and a second rotor, the first rotor of the machine is directly connected with the output shaft of the fuel engine, the second rotor of the machine is directly connected with a driving shaft, power is transmitted between the first rotor and the second rotor via electromagnetic coupling, characterized in that, the machine driven by the servo driver applies a torque load matching with the optimal efficiency operating curve at current rotational speed to the engine via the first rotor.

The advantages of the fuel engine servo loading device and optimal efficiency operating control method thereof according to the present invention are as follows: 1. the machine provided on the engine shaft in combination with the torque servo driver replaces the mechanical transmission and clutch, and the torque servo driver adjusts in a torque servo manner the torque applied to the engine shaft by the machine, and thus ensures the fuel engine to operate real time in accordance with the optimal efficiency operating curve and therefore obtains maximum mechanical energy when consuming equal fuel; 2. the fuel engine output shaft of this device is not directly and mechanically connected with external load, even if external load frequently changes or the fuel engine frequently changes the torque servo driver can still continuously, rapidly, precisely apply mating torque in a real time manner to the engine according to the requirements of the optimal efficiency operating curve, i.e., the engine always operates in accordance with the optimal efficiency operating curve at different rotational speed, so that the engine obtains maximum mechanical energy when consuming equal fuel; 3. the torque servo driver adjusts the electromagnetic torque between the first rotor and the second rotor utilizing a torque servo manner, i.e., adjusts the output shaft torque of the fuel engine, therefore, the torque servo driver can continuously adjust the torque, and the response speed that the torque servo driver can adjust the torque is in millisecond order, the adjusting preciseness and response speed outclass mechanical continuously variable transmissions (CVT) and stepped transmissions, resulting in evident energy saving effect; 4. the present device and control method are applicable to a variety of fuel engines, especially suitable for fuel and electric hybrid electric vehicle, so as to achieve the object of energy saving and lowering exhaust emission.

### BRIEF DESCRIPTION OF THE DRAWINGS

FIG. 1 is the optimal efficiency operating curve of a 1.8 L gasoline engine, in the figure, the longitudinal coordinate is the torque of the engine output shaft (in unit of N·m), the horizontal coordinate is the rotational speed of the engine output shaft (in unit of rpm), wherein the thin dash line is equipower line (in unit of kW), the thin solid line is equi-energy consumption line (in unit of g/kWh), the thick solid line is the optimal efficiency operating curve of the engine, and the thick dash line is the maximum torque limit of the engine.

FIG. 2 is a structural schematic view of a servo loading device of the fuel engine according to an embodiment of the invention, the reference numbers in the figures are as follows: 1. fuel engine, 2. engine output shaft, 3. speed/position sensor, 4. first rotor, 5. second rotor, 6. collector ring, 7. output shaft, 8. servo driver, 9. main control unit, 10. position sensor.

### DETAILED DESCRIPTION OF THE PREFERRED EMBODIMENT

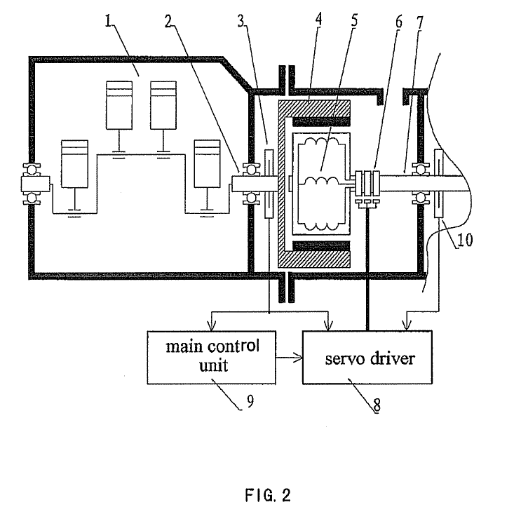

The structure of a servo loading device of the fuel engine according to an embodiment of the invention is shown in FIG. 2, the machine of the embodiment is three-phase permanent magnet synchronous electric machine. A fuel engine 1 is connected to the servo loading device comprising a permanent magnet synchronous machine, a servo driver and a main control unit. A first rotor 4 of the machine is directly connected with an output shaft 2 of the fuel engine 1. The first rotor 4 of the machine is embedded with permanent magnetic material, with a second rotor 5 therein. The second rotor 5 is a winding wound around an iron core, and the shaft of the second rotor 5 is the output shaft 7 of this device. A speed/position sensor 3 which is connected with a main control unit 9 and a servo driver 8 is provided on the first rotor 4 of the machine. A position sensor 10 which is connected with the torque servo driver 8 is provided on the output shaft 7 of this device. The main control unit 9 is connected with the servo driver 8. The servo driver 8 is connected with the winding of the second rotor 5 via a collector ring 6 provided on the second rotor shaft. The body of the main control unit 9 may be a computer, which stores therein the rotational speed-torque data matching with the optimal efficiency operating curve or the rotational speed-torque matching relation formula. The servo loading device of the fuel engine may also utilize a brushless DC machine, the structure thereof is the same as described above.

The first rotor 4 of this device may also be a winding wound around an iron core, and the collector ring 6 is provided on the engine shaft 2, which winding is connected with the torque servo driver 8 via the collector ring 6. Then the second rotor 5 is a rotor embedded with permanent magnetic material to provide magnetic field for the first rotor 4. The other arrangements may be the same as described above.

The optimal efficiency operating curve of each type of engine may be provided by the manufacturer, and may also be obtained by experiments with special testing apparatus. The optimal efficiency operating curve data may be stored in the computer of the main control unit 9 in a table or function expression manner.

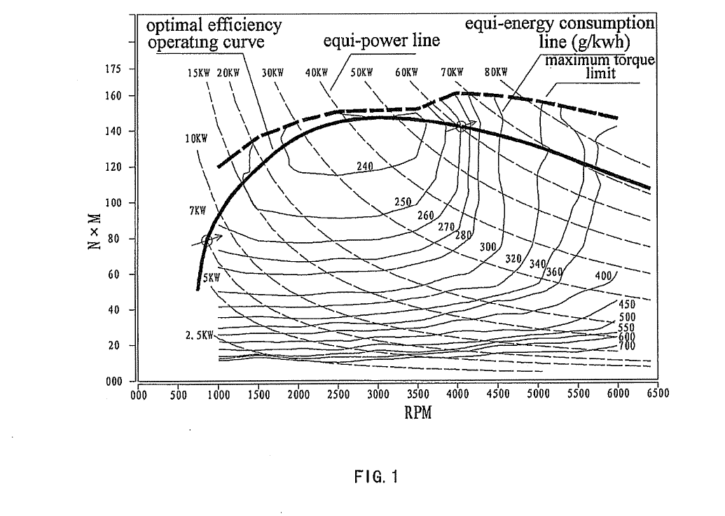

FIG. 1 is the optimal efficiency operating curve of a 1.8 L gasoline engine. The computer of the main control unit 9 according to the embodiment may store speed and torque optimal matching data in a table manner, i.e., in FIG. 1, perpendiculars are made on the engine rotational speed from idle speed to maximum rotational speed with equal spacing therebetween, a matching torque data corresponding to the rotational speed is obtained from the intersection point of the perpendicular and the optimal efficiency curve, and the rotational speed-torque optimal matching data is tabulated in the computer of the main control unit 9. When the engine rotational speed is between two intersection points, the computer of the main control unit 9 obtains the matching torque thereof based on the rotational speed signal from the sensor 3 by interpolation. It is obvious that the smaller the spacing of the rotational speed perpendicular, the higher the precision of the depicted curve of the table. As seen in FIG. 1, using the spacing of 500 revolutions per minute (rpm), 11 sets of rotational speed N-torque M data may be obtained from low speed of 1000 revolutions per minute to high speed of 6000 revolutions per minute. If using the spacing of 100 revolutions per minute (rpm), 51 sets of rotational speed N-torque M data may be obtained. If using the spacing of 1 revolution per minute (rpm), 5001 sets of rotational speed N-torque M data may be obtained.

The computer of the main control unit 9 may also store the rotational speed and torque data in a function manner, and obtains a piecewise function M=F(N) based on the optimal efficiency operating curve by mathematical processing such as computing, fitting, etc, and then this function is stored in the computer of the main control unit 9. The computer of the main control unit 9 computes corresponding optimal torque value based on the rotational speed signal of the sensor 3 with this function.

According to the present invention, the fuel engine is provided with said servo loading device matching with the maximum torque and the maximum rotational speed thereof. The optimal efficiency operating control method of the fuel engine servo loading device of this invention is as follows:

The first step: when the fuel engine 1 is operating, the first rotor 4 directly connected with the output shaft thereof rotates therewith. The speed/position sensor 3 real-time monitors current speed and position of the first rotor 4, and real time transmits the speed signal and the position signal to the computer of the main control unit 9 and the servo driver 8, respectively; the position sensor 10 real-time monitors the current position of the second rotor 5 and transmits the position signal to the servo driver 8;

The second step: the main control unit 9 derives the optimal torque expectation matching with the speed based on the current engine rotational speed signal transmitted by the speed sensor 3 according to the optimal efficiency operating curve pre-stored in the computer of the main control unit 9, and regards the expectation as the torque setting signal of the servo driver 8;

The third step: the servo driver 8 derives the relative position signal between the first rotor and the second rotor based on the absolute position signal of the first rotor and the second rotor so as to dynamically control the direction of the current vector outputting to the winding of the second rotor 5 of the machine;

The forth step: the servo driver 8 derives the magnitude of the current vector outputting to the winding of the second rotor 5 based on the torque setting value command of the main control unit 9; and

The fifth step: the servo driver 8 determines the magnitude of the instantaneous current value of the three-phase winding based on the derived direction and magnitude of the current vector, and enables the machine to realize torque servo control by the three-phase current close-loop control, so as to realize the matching optimal torque value load based on the current engine rotational speed, thereby rendering the engine to operate in accordance with the optimal efficiency operating curve and at the same time the output shaft of the second rotor 5 outputs an equal torque to the load.

The sixth step: the main control unit 9 and the servo driver 8 repeats the first step to the fifth step, thus circularly and dynamically obtaining the current engine 1 rotational speed, and deriving new torque setting value based on new current rotational speed and the pre-stored optimal efficiency curve data, and the torque servo driver 8 applies corresponding new torque value to the engine shaft 2, thus making the engine always operate in accordance with the optimal efficiency operating curve.

When the rotational speed of the engine 1 is above the rotational speed of the output shaft 7 of the second rotor 5, one portion of mechanical energy from the engine 1 is transmitted directly by the electromagnetic transmission between the first rotor and the second rotor, and the other portion thereof is transformed into electric energy to be transmitted out by the machine servo system.

When the rotational speed of the engine 1 is equal to the rotational speed of the output shaft 7 of the second rotor 5, all mechanical energy from the engine 1 is transmitted directly by the electromagnetic transmission between the first rotor and the second rotor.

When the rotational speed of the engine 1 is below the rotational speed of the output shaft 7 of the second rotor 5, all mechanical energy from the engine 1 is transmitted directly by the electromagnetic transmission between the first rotor and the second rotor, and the servo driver 8 further utilizes additional electric energy and transforms it into mechanical energy via by controlling the machine and superposes it to the output shaft so as to output it.

For example, the data of the optimal efficiency operating curve of FIG. 1 has been stored in the computer of the main control unit 9 by dividing into 11 sets in a table manner. The current rotational speed of the fuel engine 1 is 1500 revolutions per minute, the matching torque expectation obtained by the computer of the main control unit 9 through looking up the table is 118 Newton*meter(N·m). Therefore, a torque of 118 Newton*meter is applied to the output shaft 2 of the fuel engine 1 by the torque servo driver 8 controlling the current vector of the winding of the second rotor 5 of the machine. Now, the shaft of the second rotor 5 also outputs a torque of 118 Newton*meter to the load connected therewith. If the current rotational speed of the fuel engine 1 is 1800 revolutions per minute, which is between the intersection points 1500 revolutions per minute and 2000 revolutions per minute in the pre-stored table, the torque expectation to be applied which is obtained by the computer of the main control unit 9 through linear interpolation is 128.8 Newton*meter, and a torque of 128.8 Newton*meter is applied in the same way. Thereby, the sensor 3 dynamically obtains the current rotational speed of the fuel engine, and the torque servo driver 8 dynamically controls the current vector of the winding of the second rotor 5 of the machine, so that the machine dynamically applies the matching load torque to the fuel engine so as to realize that the fuel engine 1 always operates in accordance with the pre-known optimal efficiency operating curve.

When the computer of the main control unit 9 stores therein a piecewise function of the engine rotational speed and torque obtained by computing, fitting process based on the optimal efficiency operating curve, the computer of the main control unit 9 obtains a torque matching with the current rotational speed through function real time computing based on the real time rotational speed signal transmitted by the speed sensor 3.

According to one example of the invention, a 1.8 L gasoline engine is provided with this servo loading device and operates according to this optimal efficiency operating control method. As shown by point A in FIG. 1, in the case that the engine operates on the regime of 15 kW output power and keeps constant, if the engine operates on the non-economical operating point of 3500 revolutions per minute and 40.9 Newton*meter, the fuel consumption of unit output mechanical energy is 335 gram per Kilowatt hour (g/kWh). Instead, if the engine operating point is adjusted by this servo loading device and this operating control method to the point B of the optimal efficiency operating curve, i.e., 1302 revolutions per minute and 110 Newton*meter, the fuel consumption of unit output mechanical energy is 250 gram per Kilowatt hour, and thus the fuel consumption is lowered by 25.4%. The ratio of fuel consumption reduction is varied depending on different operating points.

1. A fuel engine servo loading device, comprising a permanent magnet machine having a first rotor and a second rotor, the first rotor of the machine being directly connected with an output shaft of the fuel engine, the second rotor of the machine being directly connected with a driving shaft, power being transmitted between the first rotor and the second rotor via electromagnetic coupling, characterized in that:
the fuel engine servo loading device further comprises a servo driver, which controls the electromagnetic torque between the first rotor and the second rotor according to set conditions so as to control the torque load of the fuel engine and the output torque of the driving shaft;
wherein a speed/position sensor is provided on the first rotor shaft, and a position sensor is provided on the second rotor shaft, for performing torque servo control; and
a conductive slip ring which connects an armature winding with the servo driver is provided on the rotor shaft at which the winding is mounted.

2. The fuel engine servo loading device according to claim 1, further comprising a main control unit, in which a rotational speed-torque relation data table or functional relation formula of the engine optimal efficiency operating curve is stored, such that the servo driver controls the engine to operate according to the stored rotational speed-torque relation.

3. An optimal efficiency operating control method of a fuel engine servo loading device, wherein the fuel engine is provided with said fuel engine servo loading device according to claim 1 which matches with the maximum torque and the maximum rotational speed of the fuel engine, characterized in that, said method comprises the following steps:
a) real-time monitoring the rotational speed of the first rotor of the machine by a speed/position sensor when the engine is operating;
b) the main control unit deriving, based on a speed signal, the optimal torque matching with the speed according to the rotational speed-torque matching data or the rotational speed-torque matching relation formula of the optimal efficiency operating curve pre-stored in computer, and transmitting the derived torque to the torque servo driver as a torque setting value;
c) based on the relative position signal between the first rotor and the second rotor derived from the absolute position signals of the first rotor and the second rotor, the servo driver deriving the direction of the current vector outputting to the winding of the first rotor or the second rotor according to the principle that current has the same phase with counter-electromotive force;
d) the servo driver deriving the magnitude of the current vector outputting to the winding of the first rotor or the second rotor based on the torque setting value transmitted by the main control unit;
e) the servo driver determining the magnitude of the instantaneous current value of respective phase windings based on the derived direction and magnitude of the current vector, and enabling the machine to realize torque servo control by respective phase current close-loop control, realizing the optimal toque value load matching the current engine rotational speed, such that the engine operates in accordance with the optimal efficiency operating curve and at the same time the second rotor shaft outputting the torque to the load; and
f) the main control unit and the servo driver repeating the steps of 1) to 5), thus circularly and dynamically obtaining current engine rotational speed, and deriving new torque setting value based on new current rotational speed and the pre-stored optimal efficiency curve data, and the torque servo driver applying corresponding new torque value to the engine shaft and operating by following the torque required by the engine optimal efficiency operating curve according to the rotational speed.

4. A power outputting device, comprising a fuel engine and a permanent magnet machine having a first rotor and a second rotor, the first rotor of the machine being directly connected with the output shaft of the fuel engine, the second rotor of the machine being directly connected with a driving shaft, power being transmitted between the first rotor and the second rotor via electromagnetic coupling, characterized in that:
the machine, driven by the servo driver, applies a torque load matching with the optimal efficiency operating curve at current rotational speed to the engine via the first rotor.

5. The power outputting device according to claim 4, wherein the magnitude of the machine output torque controlled by the servo driver is determined by a main control unit based on current engine rotational speed and the engine optimal efficiency operating curve stored therein.

6. The power outputting device according to claim 5, wherein the main control unit looks up the magnitude of the machine output torque from the rotational speed-torque relation of fuel engine optimal efficiency operating curve stored therein or computes it from the function relation formula thereof based on current operating parameters of the fuel engine.

7. The power outputting device according to claim 4, wherein when the machine applies matching load torque through the first rotor to the engine, the output shaft of the second rotor thereof outputs an equal torque to external load, the direction of which torque is the same as the rotational direction of the engine.

8. The power outputting device according to claim 4, wherein when the rotational speed of the engine is above the rotational speed of the output shaft of the second rotor, one portion of mechanical energy from the engine is transmitted directly by the electromagnetic transmission between the first rotor and the second rotor, and the other portion thereof is transformed into electric energy to be transmitted out by the machine servo system.

9. The power outputting device according to claim 4, wherein when the rotational speed of the engine is equal to the rotational speed of the output shaft of the second rotor, all mechanical energy from the engine is transmitted directly by the electromagnetic transmission between the first rotor and the second rotor.

10. The power outputting device according to claim 4, wherein when the rotational speed of the engine is below the rotational speed of the output shaft of the second rotor, all mechanical energy from the engine is transmitted directly by the electromagnetic transmission between the first rotor and the second rotor, and the servo driver further transforms additional electric energy into mechanical energy by controlling the machine and superposes the transformed mechanical energy to the output shaft so as to output it.

11. An optimal efficiency operating control method of a fuel engine servo loading device, wherein the fuel engine is provided with said fuel engine servo loading device according to claim 2 which matches with the maximum torque and the maximum rotational speed of the fuel engine, characterized in that, said method comprises the following steps:
a) real-time monitoring the rotational speed of the first rotor of the machine by a speed/position sensor when the engine is operating;
b) the main control unit deriving, based on a speed signal, the optimal torque matching with the speed according to the rotational speed-torque matching data or the rotational speed-torque matching relation formula of the optimal efficiency operating curve pre-stored in computer, and transmitting the derived torque to the torque servo driver as a torque setting value;
c) based on the relative position signal between the first rotor and the second rotor derived from the absolute position signals of the first rotor and the second rotor, the servo driver deriving the direction of the current vector outputting to the winding of the first rotor or the second rotor according to the principle that current has the same phase with counter-electromotive force;
d) the servo driver deriving the magnitude of the current vector outputting to the winding of the first rotor or the second rotor based on the torque setting value transmitted by the main control unit;
e) the servo driver determining the magnitude of the instantaneous current value of respective phase windings based on the derived direction and magnitude of the current vector, and enabling the machine to realize torque servo control by respective phase current close-loop control, realizing the optimal toque value load matching the current engine rotational speed, such that the engine operates in accordance with the optimal efficiency operating curve and at the same time the second rotor shaft outputting the torque to the load; and
f) the main control unit and the servo driver repeating the steps of 1) to 5), thus circularly and dynamically obtaining current engine rotational speed, and deriving new torque setting value based on new current rotational speed and the pre-stored optimal efficiency curve data, and the torque servo driver applying corresponding new torque value to the engine shaft and operating by following the torque required by the engine optimal efficiency operating curve according to the rotational speed.
